(19) United States
(12) Patent Application Publication
(10) Pub. No.: US 2015/0025975 A1
(43) Pub. Date: Jan. 22, 2015

(54) Personal Expression and Advertising Display for a Vehicle

(71) Applicant: Adam Wallach, Key Biscayne, FL (US)

(72) Inventor: Adam Wallach, Key Biscayne, FL (US)

(21) Appl. No.: 14/337,010

(22) Filed: Jul. 21, 2014

Related U.S. Application Data
(60) Provisional application No. 61/856,778, filed on Jul. 22, 2013.

(51) Int. Cl. G06Q 30/02

(52) U.S. Cl. CPC G06Q 30/0266; G06Q 30/0274
USPC 705/14.63; 705/14.62

(57) ABSTRACT

Disclosed is a device for digitally displaying personal effects on the exterior of a vehicle, including a display mounted on the exterior of a vehicle or visible from the exterior of a vehicle, a mobile controller including a storage device with personal effects of a user of the mobile controller, and a wireless packet-switched data connection on which the personal effects and at least one advertisement are received, and a short-range wireless communication mechanism, functionally associated with the display and the mobile controller, communicating the personal effects of the user and the at least one advertisement from the mobile controller to the display for display thereon, wherein the display exhibits personal effects of the user and the at least one advertisement based on input, the exhibiting based on user input or lack thereof received by way of an input mechanism of the mobile controller.

### FIELD OF THE DISCLOSED TECHNOLOGY

The disclosed technology relates generally to automobile electronics and, more specifically, to a customizable display for an automobile.

### BACKGROUND OF THE DISCLOSED TECHNOLOGY

Both advertising and personal expression have become a large part of most individuals' everyday lives. Various social networking sites allow users to share their individual personal expression with the rest of the world. Such personal expression may include photos, videos, works of art or music, writings, and any other subject of interest to a particular individual.

However, sharing of personal expression with a large group of people is typically restricted to social networking sites and the Internet, via computers, tablets and mobile devices. As such, individuals wishing to share particular items of interest require their desired audience to have Internet-connectivity, as well as some association with the individual (i.e., following the individual on Twitter, or friends with the individual on Facebook). Many individuals express their personality in other ways, such as by the car the drive. However, customizations to the car may only reveal a limited amount about a person. Thus, there is a need in the art for a means for individuals to express their social individuality publicly without being restricted to Internet connectivity or to a group of associated individuals or “friends.”

Further, advertising on social networking platforms has become a highly profitable industry. Many advertisers have ads placed on individuals' social networking pages, but there is no mechanism for the individual whose page is used for advertising to earn revenue from the advertisement or its placement.

Methods for advertising using a vehicle are also known, and are disclosed, for example, in U.S. Pat. No. 7,449,998, U.S. Pat. No. 7,426,480, and U.S. Pat. No. 6,060,993. However, none of these methods allow for the operator of the vehicle to benefit from the revenue derived from the ads, or for display of personal expression information.

Therefore, it is an object of the disclosed technology to provide a customizable and personal display to appear on the exterior of an automobile. It is further an object of the disclosed technology to provide a display for advertisements on an exterior of an automobile, where the operator of the automobile shares in the revenue from advertisements displayed.

### SUMMARY OF THE DISCLOSED TECHNOLOGY

The disclosed technology described herein addresses a need unfulfilled in the prior art by providing a device and a method for electronically displaying personal effects and advertisements on a vehicle, where a user associated with the vehicle or the electronic display shares in the revenue from the advertisements displayed.

In accordance with some aspects of an embodiment of the teachings herein, there is provided a device for digitally displaying personal effects on the exterior of a vehicle. The device includes a display mounted on the exterior of a vehicle or visible from the exterior of a vehicle, a mobile controller including a storage device with personal effects of a user of the mobile controller, and a wireless packet-switched data connection on which the personal effects and at least one advertisement are received, and a short-range wireless communication mechanism, functionally associated with the display and the mobile controller, communicating the personal effects of the user, and the at least one advertisement from the mobile controller to the display, for display thereon. The display exhibits personal effects of the user and the at least one advertisement based on input, the exhibiting based on user input or lack thereof received by way of an input mechanism of the mobile controller.

In some embodiments, the mobile controller is operated by the user to select personal effects to be communicated to the display, or to define characteristics of the personal effects to be communicated to the display.

In some embodiments, the display exhibits the at least one advertisement only when the display is idle for at least a predetermined time duration.

In some embodiments, the device further includes at least one sensor sensing location and speed characteristics of the vehicle, and providing sensed information to the mobile controller, such that the mobile controller selects at least one of the personal effects and the at least one advertisement to be displayed based on the sensed information from the at least one sensor. In some such embodiments, the at least one sensor comprises a positioning system sensing a location of the vehicle and at least one of the personal effects, and the at least one advertisement is selected based on the sensed location of the vehicle. For example, if the positioning system, such as a global positioning system (GPS), senses that the vehicle is in New-York City, the display may be programmable to display personal effects of the user which are related to New York City, such as pictures taken during a visit to the Empire State Building, or advertisements which are related to New York City, such as an advertisement for a Broadway show.

In some embodiments, the device further includes a revenue sharing mechanism in the form of an advertisement server, which improves the functionality of the display by receiving an identification of advertisements displayed on the display, determining at least location and speed characteristics of the vehicle during a period in which the advertisements are displayed on the display, determining a percentage of the revenue for the displayed advertisements to be shared based at least on the determined location and speed characteristics, and sharing with a user associated with the display the determined percentage of the revenue.

In some embodiments, the percentage of revenue shared with the user associated with the display for an advertisement is greater at locations and speeds previously determined to result in more views of the advertisement. For example, the percentage of revenue shared may be greater when driving in a metropolitan area, such as New York City, than when driving in a rural area where fewer people will see the advertisement.

In some embodiments, the number of views of the advertisement is determined based on a code exhibited in the advertisement which code is acted upon by a person outside the vehicle. For example, the advertisement may include a quick response (QR) code or a specific hyperlink, and any use of the QR code or hyperlink displayed in the advertisement is considered to reflect a view of the advertisement. In some embodiments, the number of views of the advertisement is determined based on the geolocation of users accessing information relating to the advertisement. For example, if a viewer accesses an advertised website, and the viewer's geolocation indicates that the viewer is right behind the vehicle displaying the advertisement, that is counted as a viewing of the advertisement.

In some embodiments, the percentage of revenue shared with the user associated with the display is dependent on a number of other advertisers seeking to advertise in a geographic region in which the vehicle is located. Typically, when fewer people seek to advertise in a given geographic region, a higher percentage of revenue is shared with the user.

According to an aspect of another embodiment of the present invention, there is provided a method for digitally displaying personal effects on the exterior of a vehicle, including providing a display mounted on the exterior of a vehicle or visible from the exterior of a vehicle, at a mobile controller, including a storage device with personal effects of a user of the mobile controller and a wireless packet-switched data connection, receiving the personal effects of the user and at least one advertisement, communicating the personal effects of the user and the at least one advertisement from the mobile controller to the display via a short range wireless communication system, and exhibiting the personal effects of the user and the at least one advertisement on the display based on user input or lack thereof, the user input, or lack thereof, received by way of an input mechanism of the mobile controller.

In some embodiments, the method further includes selecting at least one of the personal effects to be communicated to the display or defining characteristics of personal effects to be communicated to the display, by operating the mobile controller.

In some embodiments, the exhibiting comprises exhibiting the at least one advertisement only if the display is idle for a predetermined time duration.

In some embodiments, the method further includes selecting at least one of the personal effects and the advertisement to be displayed based on speed and location characteristics of the vehicle sensed by at least one sensor. In some such embodiments, the selecting comprises selecting the at least one personal effect and the at least one advertisement based on the location of the vehicle as sensed by a positioning system. For example, if the positioning system, such as a global positioning system (GPS), senses that the vehicle is in New-York City, the display may be programmable to display personal effects of the user which are related to New York City, such as pictures taken during a visit to the Empire State Building, or advertisements which are related to New York City, such as an advertisement for a Broadway show.

In some embodiments, the method further includes sharing revenue for displayed advertisements with a user associated with the display, by determining at least one of location and speed characteristics of the vehicle during a period in which the advertisements are displayed, determining a percentage of the revenue for the displayed advertisements to be shared, based at least on the determined location and speed characteristics, and sharing with the user the determined percentage of the revenue.

In some embodiments, the percentage of revenue shared with the user for an advertisement is greater at locations and speeds previously determined to result in more views of the advertisement. For example, the percentage of revenue shared is greater when the vehicle is being driven through a metropolitan area, such as New York City, than when being driven in a rural area where fewer people will see the advertisement.

In some embodiments, determining the percentage comprises determining the number of views of the advertisement based on a code exhibited in the advertisement, which code is acted upon by a person outside the vehicle. For example, the advertisement may include a quick response (QR) code or a specific hyperlink, and any use of the QR code or hyperlink displayed in the advertisement is considered to reflect a view of the advertisement. In some embodiments, determining the percentage comprises determining the number of views of the advertisement, based on the geolocation of users accessing information relating to the advertisement. For example, if a viewer accesses an advertised website, and the viewer's geolocation indicates that the viewer is right behind the vehicle displaying the advertisement, that is counted as a viewing of the advertisement.

In some embodiments, the percentage of shared revenue is based on a number of other advertisers seeking to advertise in a geographic region in which the vehicle is located. Typically, when fewer people seek to advertise in a given geographic region, a higher percentage of revenue is shared with the user associated with the display.

### BRIEF DESCRIPTION OF THE DRAWINGS

FIG. 1 is a high level block diagram of a device for digitally displaying personal effects and/or advertisements on the exterior of a vehicle according to an embodiment of the teachings herein.

FIG. 2 is a high level flow chart drawing of a method for digitally displaying personal effects and/or advertisements on the exterior of a vehicle, according to an embodiment of the teachings herein.

FIG. 3 shows a high level block diagram of a device that may be used to carry out the disclosed technology.

A better understanding of the disclosed technology will be obtained from the following detailed description of the preferred embodiments taken in conjunction with the drawings and the attached claims.

### DETAILED DESCRIPTION OF EMBODIMENTS OF THE DISCLOSED TECHNOLOGY

Embodiments of the disclosed technology comprise a method and device for digitally displaying personal effects of a user, and at least one advertisement, on the exterior of a vehicle. The method and device use a mobile controller including a storage device with personal effects of the user to receive input, or lack thereof, in order to select and/or control personal effects and/or advertisements to be displayed. In some embodiments, lack of input from the user regarding personal effects to be displayed results in exhibiting at least one advertisement. A user associated with the display, such as the vehicle owner or vehicle operator, shares in the revenue for displayed advertisements, where the percentage of revenue shared varies, and may depend on vehicle characteristics, such as location and speed, on the number of views of an advertisement, and/or on the number of users seeking to advertise in a specific geographic location.

Referring now to the drawings, which represent a method and device for digitally displaying personal effects of a user, and at least one advertisement, on the exterior of a vehicle, the description of same is as follows.

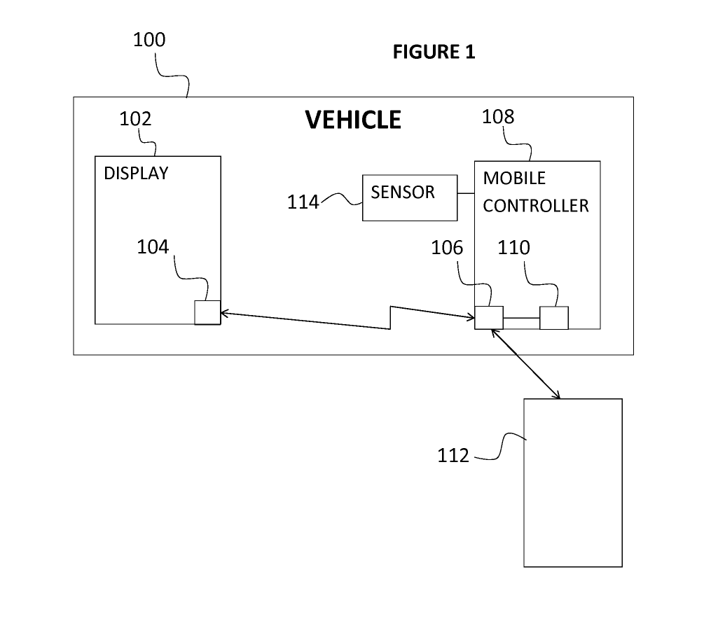

FIG. 1 is a high level block diagram of a device for digitally displaying personal effects and/or advertisements on the exterior of a vehicle, according to an embodiment of the teachings herein.

In FIG. 1, a display 102 is disposed on, in, or near a vehicle 100, such that the display 102 is visible from the exterior of the vehicle. The display 102 may be any type of screen, such a liquid crystal display (“LCD”), a light emitting diode (“LED”) display, an organic light emitting diode (“OLED), a plasma display, a digital ink display, or any other electronic and/or digital display known in the art. Vehicle 100 may be any type of vehicle, such as, for example, an automobile, a motorcycle, a truck, a van, a motorized scooter, and/or a semi-truck.

The display 102 may disposed at any location visible from the exterior of the vehicle 100, whether in the cabin of the vehicle 100 or on the exterior of the vehicle 100. In some embodiments, the display 102 is an “electronic bumper sticker,” in that it is disposed on the rear of an automobile. Thus, the display may have a width between approximately 4 inches and 24 inches, and a height between approximately 3 inches and 12 inches. In the electronic bumper sticker embodiment, the display may be disposed on a rear bumper of a vehicle in similar fashion to a bumper sticker. In other embodiments, the display 102 may be mounted inside the windows or rear windshield of the vehicle 100, facing outwards, or in any other location in the cabin of vehicle 100 which is clearly visible from the exterior of the vehicle. In another embodiment, the display 102 may be incorporated into a fuel door or tail light. In still another embodiment, the display 102 may be generally flat, such that it may be adhered or bolted onto the surface of a portion of the vehicle 100.

The display 102 may come factory-installed on a vehicle or may be installed as an after-market upgrade to a vehicle. If installed on a rear bumper (not shown), a portion of the bumper may be cut out and removed, such that the display 102 may be flush with the rest of the surface of the bumper. The display 102 may be water-proof, or otherwise weather-proof, due to exposure to the elements.

Display 102 includes a communication mechanism 104, such as a wireless packet-switched data connection used to communicate with a corresponding communication mechanism 106, such as a wireless packet-switched data connection of a mobile controller 108. Mobile controller 108 includes a storage device 110 storing personal effects of a user of the mobile controller. As explained in further detail below, mobile controller 108 controls the items shown on display 102 from within the cabin of the vehicle. Mobile controller 108 may be any suitable type of mobile computing device, such as a navigation system interface already equipped on the vehicle, a mobile phone, a laptop computer, a tablet computer, or a PD. Communication mechanisms 104 and 106 allow mobile controller 108 to send and receive data from the display 102, and may from a Bluetooth® or near-field communication connection.

As discussed in further detail below, the user may communicate with display 102 via a software application on mobile controller 108. A software application for mobile controller 108 may be specifically made for the display 102, to allow a user to customize the display in any manner. In another embodiment, the user may communicate with display 102 remotely, using a desktop computer or any other device capable of accessing the Internet. Such communication between the display and the remote computing device may be carried out over a wide-area packet-switch network or a Wi-Fi network, typically via communication mechanism 104.

In still another embodiment, a wired interface, such as a USB (universal serial bus) or other data connection may be used to communicate with the display 102. Still further, the display 102 may have a memory card slot (not shown) for loading media from a memory card onto the display 102.

Mobile controller 108 also communicates with an advertisement server 112, which also functions as a revenue-sharing mechanism, as described below.

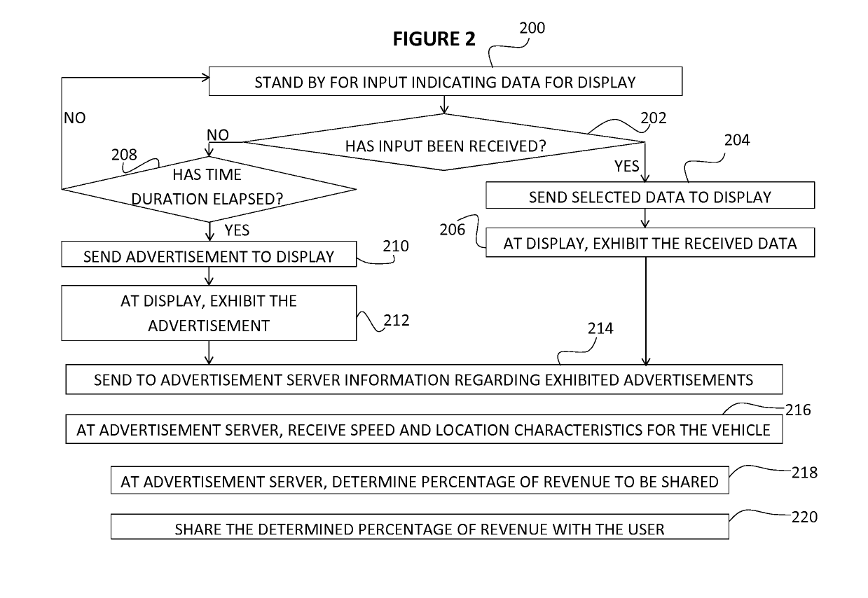

Reference is now additionally made to FIG. 2, which is a high level flow chart drawing of a method for digitally displaying personal effects and/or advertisements on the exterior of a vehicle, according to an embodiment of the teachings herein.

As seen at step 200, mobile controller 108 is on stand-by, awaiting input indicating data to be transmitted to display 102 for exhibition thereon. Occasionally or periodically, a processor (not shown) of mobile controller 108 checks whether input-indicating data to be displayed has been received, at step 202.

If such input has been received, at step 204 mobile controller 108 sends data to display 102 via communication mechanisms 104 and 106 for display thereon, at step 206.

In some embodiments, the received input is an indication of specific items to be exhibited on display 102, received from the user via a user interface of mobile controller 108. Specifically, the items to be displayed may include personal effects of the user, such as images, text and/or videos, taken from a social networking profile associated with the user. Thus, for example, a user may choose to exhibit his/her default profile picture from a social networking profile on the display 102. In another example, users may exhibit videos or text from their social networking profile, or alternatively input text from a user interface, such as that of mobile controller 108. Thus, if a user is driving to a sporting event, he/she may input a team slogan or logo to be displayed. In still another example, a user may select a plurality of images from a social networking profile to be displayed in a slide show format.

In some embodiments, mobile controller 108 is functionally associated with at least one sensor 114 for sensing location and/or speed of vehicle 100, such as an odometer or a global positioning system (GPS) receiver. In such embodiments, the input may be received from the sensor 114, and a processor of the mobile controller 108 may be programmed to automatically select items to be displayed, or stop displaying items currently displayed, based on the received sensed input. For example, if a user is driving in New York City, the mobile controller may send to the display personalized media associated with New York City for exhibition thereon.

As another example, when the vehicle begins to move or exceeds a certain speed, as indicated by input received from the odometer of vehicle 100, the processor of mobile controller 108 may terminate exhibition of videos and/or other media items which may be distracting to drivers around the vehicle 100, or may turn the display 102 off altogether. Furthermore, depending on local laws, the display may be turned off or otherwise altered upon entering a particular geographic area, as indicated by a positioning system. Thus, for example, if digital mobile video display is outlawed in Virginia, the display may be turned off upon detecting that the vehicle has crossed the state line into Virginia.

In embodiments of the disclosed technology, the display may also be used to show advertisements, and the received input may indicate that an advertisement should be displayed. The advertisements may be customized by the user via the user interface of mobile controller 108, or, alternatively, toggled based on the geographic locations as sensed by the GPS. Thus, if a user is driving near a particular retail store, advertisements directed to that store may be displayed. The time and duration of the advertisements may be customized via the user interface of mobile controller 108. Further, the user may control the toggling between advertisements and personal effects on the display.

In some embodiments, if no input is received by mobile controller 108 at step 202, the mobile controller checks whether or not a predetermined time duration has elapsed at step 208. If the predetermined time duration has not elapsed, the mobile controller 108 continues to stand by for input regarding data to be displayed. Otherwise, at step 210, if the predetermined time duration has elapsed, indicating that the display 102 has been idle for the predetermined time duration, mobile controller 108 automatically sends to display 102 at least one advertisement to be exhibited on display 102 at step 212.

In some embodiments, a user associated with the display 102, such as the vehicle owner and/or the vehicle operator, may be rewarded for exhibiting advertisements on display 102. The computation of the amount to be rewarded is carried out by advertisement server 112. The reward may be monetary, in the form of points or coupons usable at a particular retailer, or in any other suitable form.

Specifically, at step 214 of FIG. 2, mobile controller 108 sends to advertisement server 112 an indication of the advertisements displayed, as well as the duration for which each of the advertisements is, or was, displayed. In some embodiments, the advertisement server 112 is functionally associated with at least one speed or location sensor 114 of vehicle 100, and at step 216 receives from the sensor 114 speed and location characteristics of the vehicle 100 during a period in which the advertisements are exhibited on the display 102.

A processor associated with advertisement server 112 determines the percentage of revenue for the displayed advertisements to be shared with, or an equivalent of such revenue to be rewarded to, the user associated with the display 102, based at least the speed and location characteristics of the vehicle 100, at step 218. The determined percentage of revenue, or an equivalent thereof, is then shared with, or rewarded to, the user associated with display 102, such as the vehicle operator and/or vehicle owner at step 220. The reward may be monetary, in the form of points or coupons usable at a particular retailer, or in any other suitable form. In embodiments in which a percentage of the revenue is shared and the reward is monetary, the reward may be provided in any suitable financial method known in the art, such as mailing a check to the user, refunding the user's bank account or credit card, and the like.

The percentage of revenue shared with the user may be dependent on numerous aspects of the speed and location characteristics of the vehicle 100, as well as on the duration for which the advertisement is exhibited. For example, the percentage of revenue shared with the user may be greater at locations and speeds previously determined to result in more views of the exhibited advertisements. Thus, for instance, a user may be rewarded at a higher rate if driving around New York City, as opposed to, say, rural Nebraska, due to the amount of exposure from which the advertisement will benefit. As another example, the percentage of revenue shared with the user may be greater for a user driving a long distance with an advertisement exhibited, than for a user who is stuck in traffic or idling.

The number of views of the exhibited advertisement may be measured in any suitable manner. In some embodiments, the number of views of an advertisement is determined based on a code exhibited in the advertisement, which code is acted upon by a person outside the vehicle. For example, the advertisement may include a quick response (QR) code or a specific hyperlink, and any use of the QR code or hyperlink displayed in the advertisement to access information regarding the advertised product, location, or service reflects a view of the advertisement. In some embodiments, the number of views of the advertisement is determined based on the geolocation of users accessing information relating to the advertisement. For example, if a viewer accesses an advertised website, and the viewer's geolocation indicates that the viewer is right behind the vehicle displaying the advertisement, that is counted as a viewing of the advertisement.

In some embodiments, the percentage of revenue shared with the user associated with display 102, such as the vehicle operator or owner, is dependent on a number of other advertisers seeking to advertise in a geographic region in which said vehicle is located. In such embodiments, users may be paid a percentage of revenue for ads displayed, and ads are sold in an auction, based on a location of the car. That is, information about the number of cars in a given geographic area is determined, and ads are sold to advertisers, with payment made for ads based on the number of impressions on cars, the payment based on the number of other advertisers seeking advertise in the same geographic range. As cars enter or exit from such a geographic range, winning ads are displayed and revenue shared.

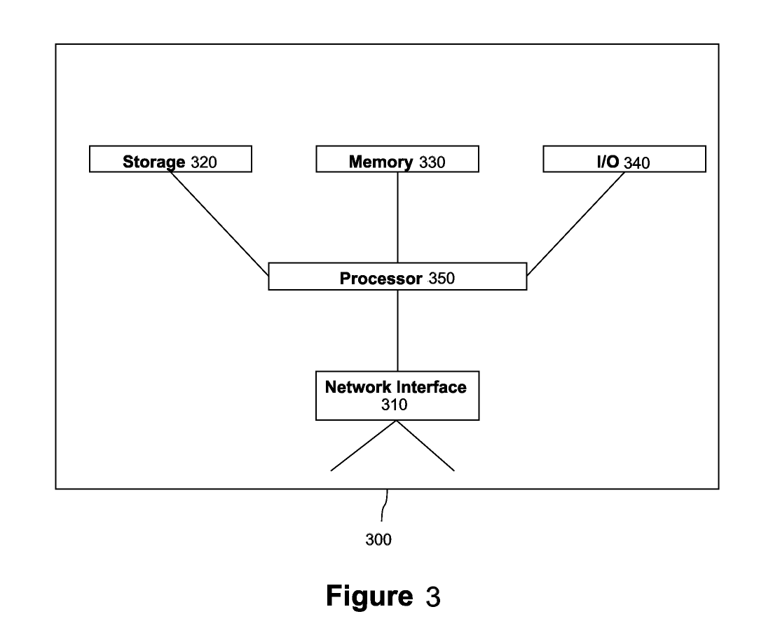

FIG. 3 shows a high-level block diagram of a device that may be used to carry out the disclosed technology. Device 300 comprises a processor 350 that controls the overall operation of the computer by executing the device's program instructions which define such operation. The device's program instructions may be stored in a storage device 320 (e.g., magnetic disk, database) and loaded into memory 330 when execution of the console's program instructions is desired. Thus, the device's operation will be defined by the device's program instructions stored in memory 330 and/or storage 320, and the console will be controlled by processor 350 executing the console's program instructions. A device 300 also includes one or a plurality of input network interfaces for communicating with other devices via a network (e.g., the Internet). The device 300 further includes an electrical input interface. A device 300 also includes one or more output network interfaces 310 for communicating with other devices. Device 300 also includes input/output 34, representing devices which allow for user interaction with a computer (e.g., display, keyboard, mouse, speakers, buttons, etc.). One skilled in the art will recognize that an implementation of an actual device will contain other components as well, and that FIG. 3 is a high level representation of some of the components of such a device, for illustrative purposes. It should also be understood by one skilled in the art that the method and devices depicted in FIGS. 1 and 2 may be implemented on a device such as is shown in FIG. 3.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. A device for digitally displaying personal effects on the exterior of a vehicle, comprising:
a display mounted on the exterior of a vehicle or visible from the exterior of a vehicle;
a mobile controller including a storage device with personal effects of a user of said mobile controller and a wireless packet-switched data connection on which said personal effects and at least one advertisement are received; and
a short-range wireless communication mechanism, functionally associated with said display and said mobile controller, communicating said personal effects of said user and said at least one advertisement from said mobile controller to said display for display thereon;
wherein said display exhibits personal effects of said user and said at least one advertisement based on input, said exhibiting based on user input or lack thereof received by way of an input mechanism of said mobile controller.

2. The device of claim 1, wherein said mobile controller is operated by said user to select personal effects to be communicated to said display or to define characteristics of the personal effects to be communicated to said display.

3. The device of claim 1, wherein said display exhibits said at least one advertisement only when said display is idle for at least a predetermined time duration.

4. The device of claim 1, further comprising at least one sensor sensing location and speed characteristics of said vehicle and providing sensed information to said mobile controller, such that said mobile controller selects at least one of said personal effects and said at least one advertisement to be displayed, based on said sensed information from said at least one sensor.

5. The device of claim 4, wherein said at least one sensor comprises a positioning system sensing a location of said vehicle, and at least one of said personal effects and said at least one advertisement are selected based on said sensed location of said vehicle.

6. The device of claim 1, further comprising a revenue-sharing mechanism in the form of an advertisement server, which improves the functionality of said display by:
receiving an identification of advertisements displayed on said display;
determining at least location and speed characteristics of the vehicle during a period in which said advertisements are displayed on said display;
determining a percentage of the revenue for said displayed advertisements to be shared with a user associated with said display, based at least on said determined location and speed characteristics; and
sharing with said user associated with said display said determined percentage of the revenue.

7. The device of claim 6, wherein said percentage of revenue shared with said user associated with said display for a said advertisement is greater at locations and speeds previously determined to result in more views of the advertisement.

8. The device of claim 7, wherein the number of views of a said advertisement is determined based on a code exhibited in said advertisement, which code is acted upon by a person outside of said vehicle.

9. The device of claim 7, wherein the number of views of a said advertisement is determined based on the geolocation of users accessing information relating to the advertisement.

10. The device of claim 6, wherein said percentage of revenue shared with said user associated with said display is dependent on a number of other advertisers seeking to advertise in a geographic region in which said vehicle is located.

11. A method for digitally displaying personal effects on the exterior of a vehicle, comprising:
providing a display mounted on the exterior of a vehicle or visible from the exterior of a vehicle;
at a mobile controller including a storage device with personal effects of a user of said mobile controller and a wireless packet-switched data connection, receiving said personal effects of said user and at least one advertisement;
communicating said personal effects of said user and said at least one advertisement from said mobile controller to said display via a short range wireless communication system; and
exhibiting said personal effects of said user and said at least one advertisement on said display, based on user input or lack thereof, said user input or lack thereof received by way of an input mechanism of said mobile controller.

12. The method of claim 11, also comprising selecting at least one of said personal effects to be communicated to said display or defining characteristics of personal effects to be communicated to said display, by operating said mobile controller.

13. The method of claim 11, wherein said exhibiting comprises exhibiting said at least one advertisement only if said display is idle for a predetermined time duration.

14. The method of claim 11, further comprising selecting at least one of said personal effects and said advertisement to be displayed, based on speed and location characteristics of said vehicle sensed by at least one sensor.

15. The method of claim 14, wherein said selecting comprises selecting said at least one personal effect and said at least one advertisement, based on the location of said vehicle as sensed by a positioning system.

16. The method of claim 11, further comprising sharing revenue for displayed advertisements with a user associated with said display, by:
determining at least one of location and speed characteristics of said vehicle during a period in which said advertisements are displayed;
determining a percentage of the revenue for said displayed advertisements to be shared, based at least on said determined location and speed characteristics; and
sharing with said user associated with said display said determined percentage of the revenue.

17. The method of claim 16, wherein said percentage of revenue shared with said user associated with said display for a said advertisement is greater at locations and speeds previously determined to result in more views of the advertisement.

18. The method of claim 17, wherein said determining of said percentage comprises determining the number of views of a said advertisement, based on a code exhibited in said advertisement, which code is acted upon by a person outside of said vehicle.

19. The method of claim 17, wherein said determining said percentage comprises determining the number of views of a said advertisement based on the geolocation of users accessing information relating to the advertisement.

20. The method of claim 16, wherein said shared percentage of revenue is based on a number of other advertisers seeking to advertise in a geographic region in which said vehicle is located.
